(19) United States
(12) Patent Application Publication
(10) Pub. No.: US 2015/0262276 A1
(43) Pub. Date: Sep. 17, 2015

(54) Catalog Barter Exchange System and Method

(71) Applicant: Sheila L. Pessah, Encinitas, CA (US)

(72) Inventor: Sheila L. Pessah, Encinitas, CA (US)

(21) Appl. No.: 14/207,156

(22) Filed: Mar. 12, 2014

(51) Int. Cl. G06Q 30/06; G06Q 20/06

(52) U.S. Cl. CPC G06Q 30/0619; G06Q 20/06

(57) ABSTRACT

A Catalog Barter Exchange System and Method. Unlike other re-sale or consignment systems, the present invention improves customer service by implementing a moderator to manage exchanges between subscribers. After subscribing, the subscriber submits for-barter materials to the moderator. Upon receipt of the items, the moderator assesses the items and responsively applies point credit to that subscribers barter account. The moderator then posts the new inventory as being part of the for-barter items in an online catalog. Subscribers are then able to redeem barter points in their barter accounts in order to “purchase” barter items from the online catalog.

This application is filed within one year of, and claims priority to Provisional Application Ser. No. 61/790,060, filed Mar. 15, 2013.

### BACKGROUND OF THE INVENTION

1. Field of the Invention

This invention relates generally to retail sales and trades of tangible goods and, more specifically, to a Catalog Barter Exchange System and Method.

2. Description of Related Art

Online retail sales of goods and services has exploded in recent years, to the point where the vast majority of shoppers will at some point (if not at first) will identify their desired good or service from an online source prior to purchasing that product or service (whether purchased online or in person). A small fraction of that online retail business has been composed of the resale of new or “gently used” second hand items. Clothing is particularly popular for the second hand resale market.

Ebay.com and amazon.com are two well-known online retail sites for the purchase of both used and new products. Both of these sites simply charge the seller a fee for allowing the seller to advertise their (new or second hand) product for sale. The fee could be a straight rate, or it could be a percentage of the sale price of the product. While these two sites are undoubtedly well-known, a variety of other attempts have been made that are specifically targeted for (although not limited to) private sellers that wish to sell or trade new or gently used clothing. FIGS. 1A-1C depict three of these examples.

FIGS. 1A, 1B and 1C are flowchart examples of prior second-hand retail disposition methods and systems.

FIG. 1A depicts the steps of a centralized resale method 10. It is believed that this is the method executed by www.thredup.com. In the centralized resale method 10, the potential seller contacts the “moderator” (i.e. the ultimate re-seller) to subscribe to the moderator's service and to obtain a submission package 102. The submission package typically is a suitable mailing envelope or box, along with an inventory recordation sheet and instructions. The moderator sends the submission package to the potential seller 104.

The seller completes and submits the submission package to the moderator 105, and upon receipt, the moderator assigns values to the individual (clothing) items in the submission package and pays the seller a percentage of the value that the moderator assigns to the inventory items 106. While this method 10 does provide a market for private party second hand goods, the seller payouts are very small (usually twenty percent of the moderator-assigned price), and therefore the seller never really gets the ability to exchange anything of true value for their fine used goods.

FIG. 1B depicts the steps of a peer-to-peer sale/trade method 12. This method is similar to that provided by www.ebay.com, as well as others (e.g. www.bigwardrobe.com). Effectively, the website provider is not involved in the transfer of goods, but rather offers a communications medium to put buyers and sellers (or traders) together. The subscriber trader first creates a profile 108 with the service-provider, and then lists their items for sale or trade 110. Interested buyers or barter partners then consummate the sale or trade transaction 112 according to the guidelines and agreements provided by the service-provider at their website. Since this method 12 does not provide for a evolving catalog of inventory at consistent, listed prices, it cannot provide a consistent service and controllable value for products up for sale or trade. Essentially, whatever the market bears at a particular time will determine the price—many transactions will simply not occur because of the lack of predictability (particularly in the case of barter/swaps).

Finally, FIG. 1C depicts the flow process for a conventional consignment sale method 14. There are numerous brick and mortar and online examples of this sale method 14. Essentially, the seller provides their goods to the consignor (by shipping or personal delivery) 114, and the consignor sells the goods (or not), and then pays the seller a percentage of the sales price 116 (usually not more than about 15 percent). This method 14 is, therefore, limited in its utility and desirability because there is a built-in extra charge related to the consignor's costs, and it does not really provide for a free-market barter environment.

What is needed is a system that provides sellers and buyers with a low-cost barter/swap transaction, while also offering the security and standardization of moderated, centralized control.

### SUMMARY OF THE INVENTION

In light of the aforementioned problems associated with the prior methods and systems, it is an object of the present invention to provide a Catalog Barter Exchange System and Method. Unlike other re-sale or consignment systems, it is a goal that the present invention improve customer service by implementing a moderator to manage exchanges between subscribers. After subscribing, the subscriber should submit for-barter materials to the moderator. Upon receipt of the items, the moderator should assess the items and responsively apply point credit to that subscribers barter account. The moderator should then post the new inventory as being part of the for-barter items in an online catalog. Subscribers should be able to redeem barter points in their barter accounts in order to “purchase” barter items from the online catalog.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIGS. 1A, 1B and 1C are flowchart examples of prior second-hand retail disposition methods and systems;

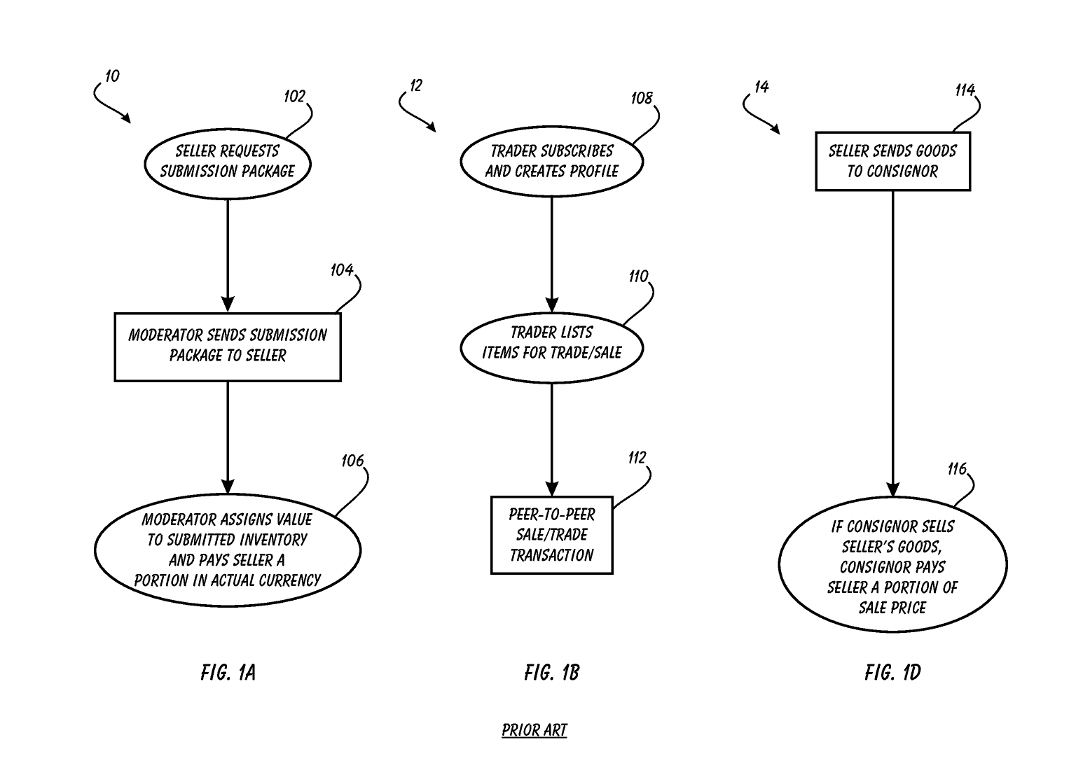

FIG. 2 is a flowchart depicting a preferred embodiment of the catalog barter exchange method of the present invention;

FIG. 3 depicts the transaction types related to the subscriber barter account of the method and system of FIG. 2; and

FIG. 4 depicts the conventional sequence of events as between two subscribers and the moderator in the system and method of FIG. 2.

### DETAILED DESCRIPTION OF THE PREFERRED EMBODIMENTS

The following description is provided to enable any person skilled in the art to make and use the invention and sets forth the best modes contemplated by the inventor of carrying out her invention. Various modifications, however, will remain readily apparent to those skilled in the art, since the generic principles of the present invention have been defined herein specifically to provide a Catalog Barter Exchange System and Method.

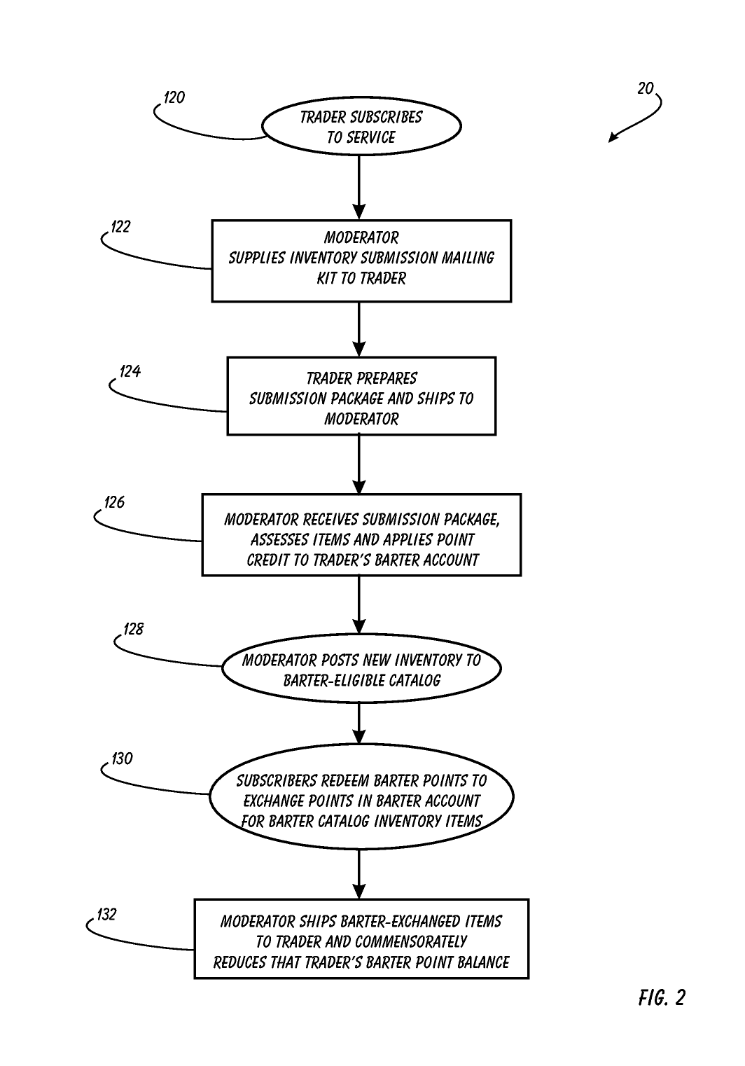

The present invention can best be understood by initial consideration of FIG. 2.¹ FIG. 2 is a flowchart depicting a preferred embodiment of the catalog barter exchange method 20 of the present invention. The (prospective) trader must first subscribe to the service 120. In response, the moderator (at the provider of the service) will supply an inventory mailing kit to the trader (typically by mail, but could be hand-delivered at a store front location) 124. ¹ As used throughout this disclosure, element numbers enclosed in square brackets [ ] indicates that the referenced element is not shown in the instant drawing figure, but rather is displayed elsewhere in another drawing figure.

In a preferred form, there would be a variety of membership levels available for subscription. The specific benefits and responsibilities for each level of membership will change over time and other circumstances. The following membership levels might be implemented (provided solely as an example of possible options): a “window shopper” membership is intended for the infrequent “shopper.” It is “pay-as-you-go,” where the subscribed member is able to visit the online catalog, but must pay in advance for additional inventory mailing kits (including the initial kit). A “seasonal shopper” is intended for the client that wishes to try out the service, but wants a short-term commitment. In addition to the initial inventory mailing kit, this level of membership entitles the client to an additional inventory mailing kit (i.e. a total of two mailing kits are included as a part of the membership). A “trendy shopper” is a six-month membership that includes two additional inventory mailing kits, as well as potentially bonus points being credited to the subscriber's barter account (e.g. 60 points) and reduced shipping rates. Finally, a “fashionista” is a one-year membership that includes four additional inventory mailing kits, bonus barter points (e.g. 150), and reduced shipping rates.

Once the inventory mailing kit is received, the trader prepares a submission package of items desired to swap (e.g. dresses, shirts, sweaters, shoes, outerwear, accessories, etc.), and ships the package to the moderator 124. Upon receiving the trader's submission package (within a short time thereafter, such as seven days), the moderator will assess the items and apply the appropriate point credit (according to a pre-set range of points per class of item) to that trader's barter account. For example, a pair of basic pants may be “worth” 40 to 50 points, while a pair of dress pants might be worth 50 to 60 points. Premium denim jeans might be worth 120-130 points under such a scale. The purpose of pre-setting point value ranges and having the moderator actually set the value of a particular item is to create a stable market within which all traders can benefit. Furthermore, unlike the ebay.com model, the traders remain anonymous to one another, for privacy and security reasons.

Once inventoried and assessed, the moderator will add the newly submitted items to the catalog of all items that is accessible by the general public over the moderator's website 130. Only subscribers can make transactions through the moderator's site by redeeming points from their individual barter accounts for the catalog items available for “purchase.”

Once a subscriber has requested a redemption for an item, the moderator will ship those items (or make them available for pickup at a physical storefront) to the trader and will reduce that trader's barter account point balance for the appropriate amount 132.

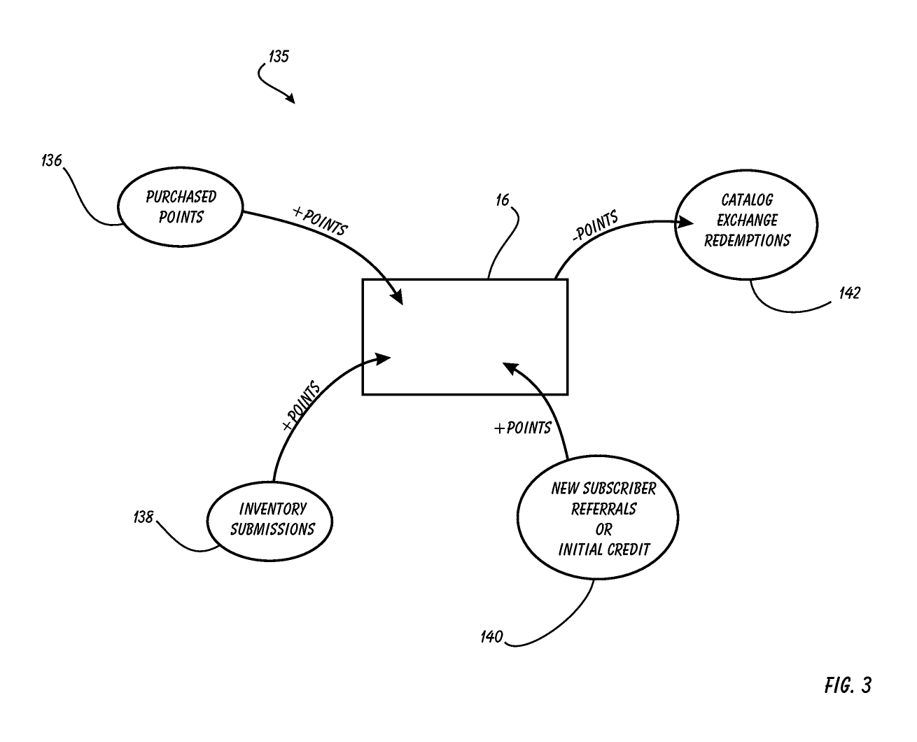

FIG. 3 depicts the transaction types 135 related to the subscriber barter account of the method and system of FIG. 2. The barter account 16 contains only points. There is no cash value for the points outside of the ability to exchange or redeem points for catalog items. Points can be added by purchasing them 136, by submitting inventory 138, by moderator credit (such as for referrals of new subscribers or as a part of the initial membership package) 140. Points are deducted from the barter account 16 by catalog exchange redemptions (“purchases”) 142, or by transferring points to another trader's barter account 144.

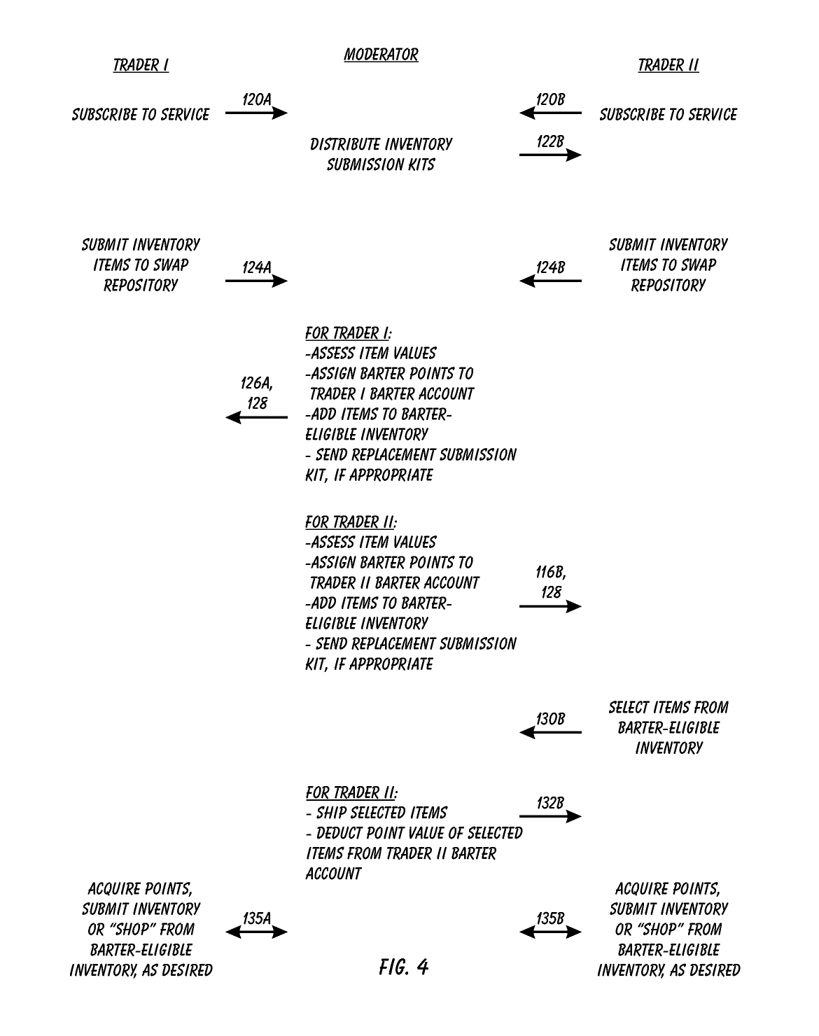

FIG. 4 depicts the conventional sequence of events as between two subscribers and the moderator in the system and method of FIG. 2. The point of this diagram is to show how a pair of traders' transactions will work together. Of course, the intent is to have tens, hundreds, or even thousands (or more) traders subscribed to the system and actively conducting transactions—this limited scenario is simply an example of the process in action.

The traders both subscribe to the service 120A, 120B, and in response the moderator sends them each an inventory submission kit 122A, 122B. They both submit their inventory items for inclusion in the swap repository (the catalog) 124A, 124B. The moderator assesses the items values, assigns barter points as a credit to the particular trader's barter account and posts the added inventory to the online catalog. Depending on membership level and the moderator's policies at the time, a replacement submission kit may or may not be sent to each trader (the replacement kits may already be in the hands of the trader, depending on membership level) 126A, 126B, 128. Typically, will receive a kit (out of their annual allocation for kits) by mail upon request. The higher membership levels receive a discount on the submission kits, as a membership level benefit.

If Trader II wishes to make a redemption, he or she selects items from the barter-eligible inventory (i.e. the catalog) 130B. These items would be inventory obtained from Trader I (or other subscribers). The moderator ships the selected items and deducts the appropriate point total from Trader II's barter account. Trader II might also be able to physically pick up the package at the moderator's brick and mortar store.

Expanding this scenario going forward, Trader I and Trader II (and hopefully many other traders) will continue to add points to their barter accounts and redeem those points for catalog items according to the pre-established transaction scheme [135].

While the following Claims detail a moderator, a valuation manager, and an inventory manager, these positions are illustrative of functional roles only. These functional positions are not intended to convey that each role is held by any specific number of individuals. In fact, in some cases, all roles may be performed by a single individual.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. An apparatus for facilitating a transaction between a barter moderator and at least one of a plurality of traders, comprising:
a storage device; and
a processor connected to the storage device, the storage device storing a program for controlling the processor; and
the processor operative with the program to:
receive a barter point value representative of an item submitted by a trader to a barter group of items;
receive an order from said trader for an item in said barter group of items;
deduct one or more points from a trader-attributed barter point account responsive to said order, and
record that said ordered item was sent to said trader.

2. A method for using a computer to facilitate an exchange transaction between one or more traders and a centralized pool of items, comprising the steps of:
a moderator establishes a barter group of items;
an inventory manager publishes an itemized catalog of said barter group of items, each said item in said catalog having a barter point value associated with it, and with said itemized catalog being viewable by potential traders at one or more networked computing devices;
a first trader establishes a barter point account with said moderator via one of said networked computing devices;
said first trader submits additional items to said moderator for inclusion in said barter group of items;
a valuation manager assesses said additionally submitted items and assigns a point value responsive to said assessment;
said moderator attributes said assigned point value to said first trader's account barter point account;
said first trader orders a first item contained in said barter group of items from said moderator via one of said networked computing devices;
said moderator reduces the barter point account balance for said first trader by the amount of said barter points attributed to said first item; and
said inventory manager sends said first item to said first trader.

3. The method of claim 2, further comprising an additional inventory addition step after said moderator attributes said assigned point value to said first trader's barter point account, said additional inventory addition step comprising said inventory manager adding said additionally submitted items to said published catalog;

4. The method of claim 3, further comprising a kit mailing step prior to said first trader submitting additional items step, said kit mailing step comprising said moderator sending said first trader an inventory submission mailing kit to said first trader.

5. A method for using a computing device to facilitate a transaction between a plurality of traders and a barter pool of items, comprising:
inputting into the computing device one or more points into a barter point account attributed to a said trader;
inputting into the computing device an order for an item in said barter pool of items from a said trader;
deducting points from a barter point account attributed to said ordering trader, said deduction responsive to a prior evaluation of said ordered item, said deduction inputted into the computing device;
inputting the transfer of said ordered item to said ordering trader into the computing device; and
deducting said ordered and transferred item from said barter pool of items into the computing device.

6. The method of claim 5, further comprising a step of inputting into the computing device a received item from from a said trader prior to said imputing one or more points step.

7. The method of claim 6, further comprising a step of inputting into the computing device said received item into said barter pool of items.

8. The method of claim 7 further comprising a step of inputting into the computing device one or more points into a barter point account attributed to a said trader responsive to said received item.
